(19) United States
(12) Patent Application Publication
(10) Pub. No.: US 2010/0303700 A1
(43) Pub. Date: Dec. 2, 2010

(54) PROCESS FOR TREATING A GAS STREAM OR EFFLUENT

(76) Inventors: Nagaraju Palla, Woodridge, IL (US); Lamara A. Davis, West Dundee, IL (US); David Holbrook, Palatine, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/475,102

(22) Filed: May 29, 2009

(51) Int. Cl. B01D 53/48

(52) U.S. Cl. 423/242.1

(57) ABSTRACT

One exemplary embodiment can be a process for treating a tail gas stream from a sulfur recovery zone. Generally, the process includes passing the tail gas stream through, in sequence, a hydrogenation zone, a quench zone, and an acid gas removal zone using a solvent. The solvent can include at least one of a dimethyl ether of polyethylene glycol, a N-methyl pyrrolidone, a N-formyl morpholine, a N-acetyl morpholine, a tetrahydro-1,4-oxazine, and a mixture comprising diisopropanolamine and tetrahydrothiophene-1,1-dioxide.

### FIELD OF THE INVENTION

This invention generally relates to a process for treating a gas stream or effluent.

### DESCRIPTION OF THE RELATED ART

Generally, it is desired to remove sulfur-containing compounds from a gas stream before discharging them to the environment or utilizing them for fuel gas. In addition, often such sulfur-containing compounds are removed to prevent corrosion or catalyst poisoning with downstream processing units.

Often, a Claus unit may be used to remove sulfur. Due to continually stringent regulations, often insufficient sulfur is removed for utilizing gases, such as a tail gas, emanating from a Claus unit. Consequently, additional processing is required, which often requires industry standard units, such as a Shell Claus Off gas Treating (hereinafter may be abbreviated “SCOT”) unit. However, such units may not remove sufficient amounts of various gases to permit additional processing and/or recycling of the treated gases. Moreover, other processes, such as the gasifying of coal or petroleum coke can produce undesired levels of contaminants, such as sulfur, in streams emanating from such a unit. It would be desirable to remove acidic gases, such as hydrogen sulfide (H₂S), carbonyl sulfide (COS), and carbon dioxide (CO₂), to allow processing in other units. Thus, it would be desirable to provide an integrated system that can process these various gas streams in an integrated and economic manner.

### SUMMARY OF THE INVENTION

One exemplary embodiment can be a process for treating a tail gas stream from a sulfur recovery zone. Generally, the process includes passing the tail gas stream through, in sequence, a hydrogenation zone, a quench zone, and an acid gas removal zone using a solvent. The solvent can include at least one of a dimethyl ether of polyethylene glycol, a N-methyl pyrrolidone, a N-formyl morpholine, a N-acetyl morpholine, a tetrahydro-1,4-oxazine, and a mixture comprising diisopropanolamine and tetrahydrothiophene-1,1-dioxide.

Another exemplary embodiment may be a process for treating a tail gas stream from a sulfur recovery zone. The process can include passing the tail gas stream through a hydrogenation zone. The hydrogenation zone can include a first exchanger for preheating the tail gas stream before entering the hydrogenation zone, a hydrogenation catalytic reactor receiving a reducing gas comprising a syngas, and a second exchanger for reclaiming heat from a hydrogenation catalytic reactor effluent.

Yet another exemplary embodiment can be a process for treating an effluent from a gasification zone. The process can include passing the effluent through, in sequence, at least one of a carbon monoxide shift zone and a carbonyl sulfide hydrolysis zone, an acid gas removal zone, a sulfur recovery zone, and a hydrogenation zone.

The embodiments disclosed herein can provide an integrated system for removing sulfur from a tail gas stream of a Claus unit or other gas streams to a sufficient degree to allow their subsequent use with other process units, such as an acid gas removal zone, or for release to the environment. Thus, the utilization of an acid gas removal zone in combination with a hydrogenation zone can economically and succinctly provide the appropriate treatment for these streams. In addition, the use of additional zones, such as a carbon monoxide shift zone and carbonyl sulfide hydrolysis zone, may provide additional flexibility in cleaning process streams. As a consequence, the utilization of these various zones can economically and efficiently purify various streams and allow their proper disposal.

### Definitions

As used herein, the term “stream” can be a stream including various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules. Additionally, characterizing a stream as, e.g., a “hydrocarbon stream”, a “gas stream” and a “tail gas stream” can mean a stream rich in, respectively, at least one hydrocarbon, gas, and tail gas.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the terms “absorbent” and “absorber” may include, respectively, an adsorbent and an adsorber, and relates, but is not limited to, absorption, and/or adsorption.

As used herein, the term “vapor” can mean a gas or a dispersion that may include or consist of one or more hydrocarbons.

As used herein, the term “rich” can mean an amount of at least generally about 30%, and preferably about 50%, by mole, of a compound or class of compounds in a stream.

As depicted, process flow lines in the figures can be referred to as lines, effluents, feeds, or streams. Particularly, a line can contain one or more effluents, feeds, and streams, and one or more effluents, feeds, and streams can be contained by a line.

### BRIEF DESCRIPTION OF THE DRAWINGS

FIG. 1 is a schematic depiction of various zones used to process a tail gas stream from a sulfur recovery zone.

FIG. 2 is a schematic depiction of an acid gas removal zone.

FIG. 3 is another exemplary schematic depiction of various zones used to process a gas from a gasification zone.

### DETAILED DESCRIPTION

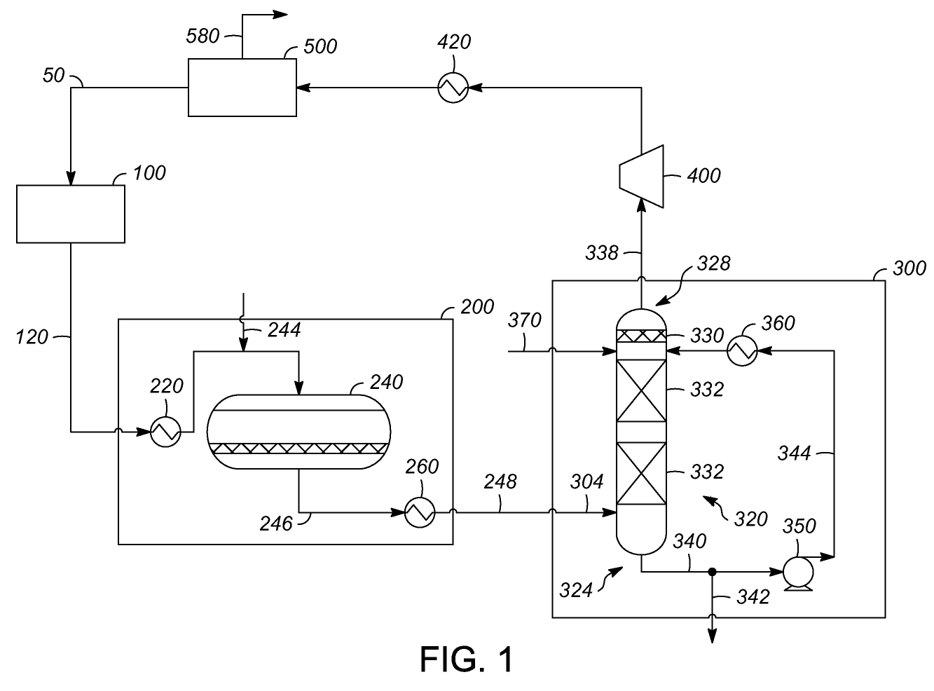

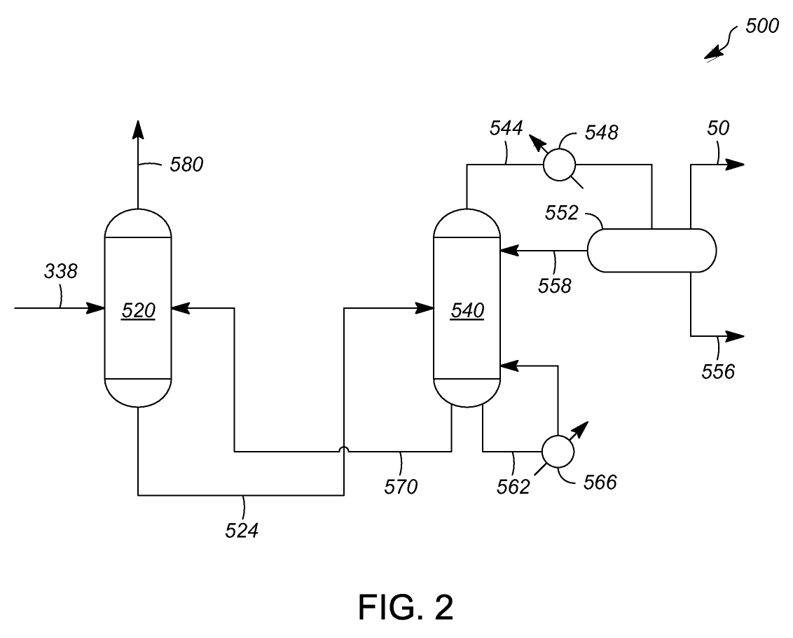

Referring to FIGS. 1-2, several zones, namely a sulfur recovery zone 100, a hydrogenation zone 200, a quench zone 300, and an acid gas removal zone 500 can be utilized to treat and recycle a stream including one or more sulfur compounds. Particularly, the sulfur recovery zone 100 can utilize Claus reactions to recover sulfur from a feed 50 and produce a tail gas stream 120. The feed 50 can include an effluent from an acid removal zone 500, as well as other sour gases, such as a sour water stripper gas containing ammonia and sulfur compounds, from other hydrocarbon manufacturing or refining units, such as gasification units and natural gas processing units. Typically, the tail gas stream 120 is at no more than about 150° C. after exiting the sulfur recovery zone 100. Exemplary sulfur recovery zones are disclosed in, e.g., U.S. Pat. No. 4,425,317, U.S. Pat. No. 5,512,260, and US 2008/0247927 A1.

Subsequently, the tail gas stream 120 can enter the hydrogenation zone 200. The hydrogenation zone 200 can include a first exchanger 220, a hydrogenation catalytic reactor 240, and a second exchanger 260. The first exchanger 220 can preheat the tail gas stream 120 before entering the hydrogenation catalytic reactor 240. Any suitable heat source may be used for the first exchanger 220, such as medium pressure steam. Typically, the hydrogenation catalytic reactor 240 can operate at a temperature of about 260—about 330° C. In addition, the hydrogenation catalytic reactor 240 can receive a reducing gas stream 244. The reducing gas stream 244 can be any suitable gas, such as hydrogen or a syngas including, e.g., at least one of hydrogen and carbon monoxide. A suitable hydrogenation catalytic reactor is disclosed in, e.g., U.S. Pat. No. 4,425,317 and U.S. Pat. No. 5,512,260. Suitable catalyst can include cobalt and/or molybdenum catalyst. The hydrogenation catalytic reactor 240 can produce a hydrogenation catalytic reactor effluent 246. Sulfur compounds, such as sulfur dioxide, carbonyl sulfide, sulfur vapor, and carbon disulfide, can be hydrogenated and/or hydrolyzed into hydrogen sulfide. Exemplary reactions and reaction products are disclosed in, e.g., U.S. Pat. No. 5,512,260. The hydrogenated catalytic reactor effluent 246 can enter the second exchanger 260. The second exchanger 260 can cool the hydrogenation catalytic reactor effluent 246 and optionally can reclaim heat from the catalytic reactor effluent 246 by producing, e.g., low or medium pressure steam. Subsequently, a hydrogenation zone effluent 248 may leave the hydrogenation zone 200 and be received by the quench zone 300.

The quench zone 300 can include a quench column 320, a fluid transfer device 350, such as a pump, and an exchanger 360. The quench column 320 can have a lower end 324, an upper end 328 and contain a demister 330. Generally, the quench column 320 can reduce the hydrogen sulfide and water content of the hydrogenation zone effluent 248.

Particularly, the quench column 320 can receive the hydrogenation zone effluent 248 as a feed 304 at the lower end 324 and a stream 370 including water at the upper end 328. In addition, the quench column 320 can contain one or more packed beds 332, such as two packed beds 332. Generally, the feed 304 enters the quench column 320, rises and contacts the water passing downward. As the gases rise through the packed beds 332, direct contact with water can cool the gases and condense the water vapor. The gases can continue to rise in the quench column 320 and pass through the demister 330 removing suspended liquid particles. The demister 330 can be a vane or mesh demister. Preferably the demister 330 is a mesh. Afterwards, the gas can continue to rise and exit the quench column 320 past its upper end 328 as a quench column effluent 338.

A bottom stream 340 can be sent to the fluid transfer device 350 with a slipstream 342 being withdrawn. Generally, the slipstream 342 can include sour water. The pump 350 can provide a water recycle stream 344 to an exchanger 360. The exchanger 360 can cool the water recycle stream 344 before entering the quench column 320. Optionally, a side-stream (not depicted) may be withdrawn and passed through a filter to remove solids with a portion disposed in the slipstream 342 and the remainder recycled to the quench column 320 via a suction of the fluid transfer device 350.

The quench column effluent 338 can be received in another fluid transfer device 400, such as a compressor. The quench column effluent 338 can include carbon dioxide with small amounts of hydrogen, carbon monoxide, nitrogen, water, hydrogen sulfide and traces of carbonyl sulfide. The compressor 400 can provide the gas at a pressure of up to about 10,000 kPa, preferably up to about 8,000 kPa. As such, the quench column effluent 338 can be at suitable conditions, e.g., pressure, temperature, and composition, for processing by the acid gas removal zone 500 for removing sulfur compounds. Afterwards, the compressed gas can be received by a heat exchanger 420 and cooled. That being done, the quench column effluent 338 can then pass to the acid gas removal zone 500.

Referring to FIG. 2, the acid gas removal zone 500 can include an absorber 520 and a solvent regenerator column 540. Typically, the quench column effluent 338 from the exchanger 420 can enter the absorber 520. The absorber 520 can remove sulfur-containing compounds such as hydrogen sulfide. The absorber 520 can provide a treated gas stream 580 that either can be utilized in the fuel gas system, be released into the environment, or be used in subsequent hydrocarbon processes. An exemplary acid gas removal zone is depicted in, e.g., U.S. Pat. No. 6,090,356.

Generally, the absorber 520 operates at a temperature of about 4—about 60° C. and a pressure of up to about 10,000 kPa, preferably about 8,000 kPa. Typically, a solvent is used in the absorber 520. The solvent can include at least one of a dimethyl ether of polyethylene glycol, a N-methyl pyrrolidone, a N-formyl morpholine, a N-acetyl morpholine, a tetrahydro-1,4-oxazine, and a mixture including diisopropanolamine and tetrahydrothiophene-1,1-dioxide. Preferably, the solvent includes a dimethyl ether of polyethylene glycol. The bottom stream 524 including the solvent can be sent to the solvent regenerator column 540.

Typically, the solvent regenerator column 540 can provide an overhead stream 544, a reboiling stream 562, and a bottom stream 570. The reboiling stream 562 can enter a reboiler 566 and be returned to the solvent regenerator column 540. The overhead stream 544 can be passed to an exchanger 548 and be cooled, and then be sent to a receiver 552. The receiver 552 can provide a reflux 558 back to the solvent regenerator column 540. In addition, a stream 50 including sulfur can be the feed 50 to the sulfur recovery zone 100 as depicted in FIG. 1. The receiver 552 can also provide a stream 556 including water. In addition, the bottom stream 570 including a lean solvent can be recycled to the absorber 520.

In this manner, essentially all the sulfur that is not recovered from the acid gas by the sulfur recovery zone 100 can be recaptured by the acid gas removal zone 500 and put back into the sulfur recovery zone 100. Generally, the tail gas stream is now free of corrosive sulfur dioxide and of elemental sulfur that can plug processor and analytical equipment. The tail gas stream 120 can be easily integrated into a physical solvent process and completely eliminate the need for a separate tail gas treating unit. Thus, the proposed method can be integrated into the acid gas removal zone 500 for natural gas and synthetic gas applications and eliminate standard units, such as a SCOT unit, while achieving an overall sulfur recovery efficiency of at least about 99%, by weight, preferably at least about 99.9%, by weight, based on the initial sulfur amount in the tail gas stream 120 and meeting other emission requirements.

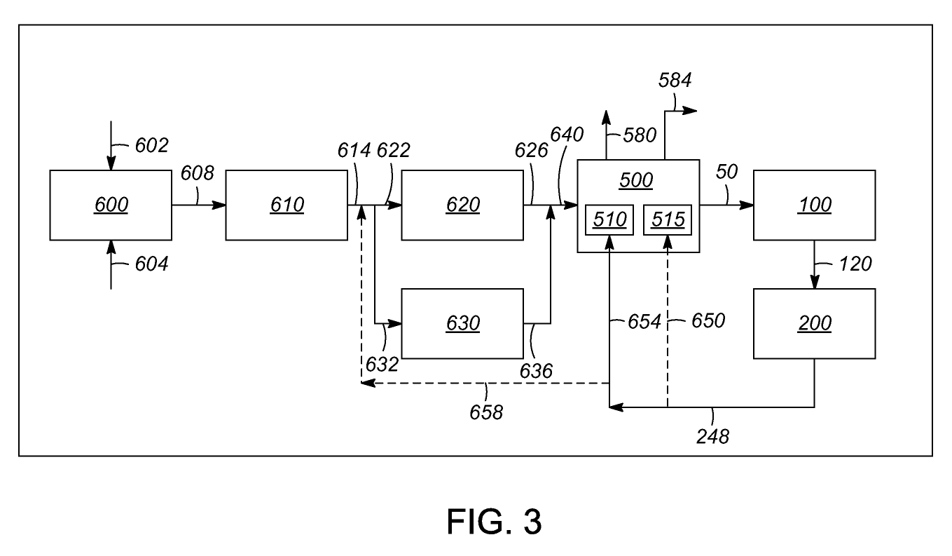

Referring to FIG. 3, the sulfur recovery zone 100 and the hydrogenation zone 200 can be utilized with other gas streams for reducing sulfur content. Particularly, a gasification zone 600 can receive a stream 602 including oxygen and a feed 604 of coal and/or petroleum coke. The gasification zone 600 can provide an effluent 608 to a syngas scrubbing zone 610, which can use any suitable scrubbing fluid, such as water. The syngas scrubbing zone 610 can, in turn, provide a syngas scrubbing zone effluent 614 including a plurality of gases that can optionally be split as a feed 622 to a carbon monoxide shift gas zone 620 and a feed 632 to a carbonyl sulfide hydrolysis zone 630.

The carbon monoxide shift zone 620 can use a shift process reacting carbon monoxide with steam to produce hydrogen and carbon dioxide. Such a process is disclosed in, e.g., U.S. Pat. No. 4,142,988. The reaction can occur in one or more reaction beds containing a catalyst. The catalyst can include at least one metal from group VIA, such as chromium, molybdenum, and tungsten; and group VIII, such as iron, cobalt, and nickel. The reaction can be at a pressure of at least about 2,500 kPa, preferably at least about 5,000 kPa, and a temperature of about 180—about 400° C. Generally, the temperature can rise from the inlet to the outlet of the reaction beds. As such, the effluent 626 from the carbon monoxide shift zone 620 can be cooled in one or more exchangers to produce steam and/or be cooled with cooling water.

The carbonyl sulfide hydrolysis zone 630 may receive a feed 632 from the syngas scrubbing zone effluent 614. The carbonyl sulfide hydrolysis zone 630 can include a reactor containing any suitable catalyst that may include at least one of, e.g., nickel, platinum, palladium, cobalt, rhodium, and indium. Generally, a hydrolysis reaction can be conducted at a temperature of about 0—about 400° C., preferably about 25—about 200° C., and a pressure of about 100 kPa—about 2,500 kPa. Exemplary carbonyl sulfide hydrolysis zones are disclosed in, e.g., U.S. Pat. No. 5,674,463 and US 2009/0004096 A1. An effluent 636 can exit the carbonyl sulfide hydrolysis zone 630. The effluents 626 and 636 can be combined as a feed 640 before entering another version of the acid gas removal zone 500.

The acid gas removal zone 500 can include a hydrogen sulfide section 510 and a carbon dioxide section 515. The hydrogen sulfide section 510 can include at least some of the equipment discussed above. Generally, the hydrogen sulfide section 510 can remove hydrogen sulfide from a hydrogen sulfide section feed 654 and the carbon dioxide section 515 can remove carbon dioxide from a carbon dioxide section feed 650. Generally, each of the sections 510 and 515 can include absorbers for removing respectively, hydrogen sulfide and carbon dioxide. Exemplary sections for removing hydrogen sulfide and carbon dioxide are disclosed in, e.g., U.S. Pat. No. 6,090,356. The acid gas removal zone 500 can provide a treated gas stream 580, as discussed above, and a carbon dioxide stream 584 vented from the zone 500. Moreover, the acid gas removal zone 500 can provide the feed 50 containing sulfur to the sulfur recovery zone 100, which in turn can provide a tail gas stream 120 to the hydrogenation zone 200, as discussed above.

The hydrogenation zone effluent 248 can be provided to one or more locations as depicted in FIG. 3. Particularly, the hydrogenation zone effluent 248 can be provided to the hydrogen sulfide section 510, or the carbon dioxide section 515. Alternatively, the hydrogenation effluent 248 can be bypassed around the acid gas removal zone 500 and be provided via a stream 658 upstream of the zones 620 and 630. Thus, additional gases can be removed from this stream, such as carbon monoxide and carbonyl sulfide. This arrangement of zones as depicted in FIG. 3 can provide additional flexibility in removing hydrogen sulfide and other compounds depending on the hydrogenated gas stream composition and relevant environmental regulations.

### Illustrative Embodiment

The following example is intended to further illustrate the subject process. This illustration of the embodiments of the invention is not meant to limit the claims of this invention to the particular details of this example. This example is based on engineering calculations and actual operating experience with similar processes.

The typical oxygen blown Claus unit tail gas composition range is provided in the following table.

TABLE 1

| | Range |
|---|---|
| | (mole %, unless otherwise |
| Gas Composition | specified) |
| H₂ | 0.3-1.5 |
| N₂ | 3-6 |
| H₂O | 30-50 |
| CO | 0.1-1 |
| CO₂ | 10-60 |
| H₂S | 0.5-1.5 |
| SO₂ | 0.3-1.0 |
| CS₂ | 0.02-0.1 |
| COS | 0.02-0.2 |
| Liquid sulfur | 0.01-0.1 |
| Sulfur Vapor (as S8 | 0.01-0.2 |
| molecules) | |
| Temperature, ° C. | 138-166 |
| Pressure, kPa | 214-276 |

Generally, the tail gas stream can be hydrogenated by heating with medium pressure steam in a hydrogenation reactor feed heater. The heated gas is then mixed with a hydrogen rich reducing gas before the mixture flows to a hydrogenation reactor. As the gas flows through a bed of cobalt and molybdenum catalyst, the reducing atmosphere hydrogenates or hydrolyzes most of the sulfur compounds to hydrogen sulfide. Referring to Table 2, the typical hydrogenated stream composition can be as follows:

TABLE 2

| | Range |
|---|---|
| | (mole %, unless otherwise |
| Gas Composition | specified) |
| H₂ | 2-5 |
| N₂ | 4-7 |
| H₂O | 0.3-0.7 |
| CO | 0.03-0.1 |
| CO₂ | 10-90 |
| H₂S | 2.0-4 |
| SO₂ | 0 |
| CS₂ | 0 |
| COS | 0.02-0.1 |
| Liquid sulfur | 0 |
| Sulfur Vapor (as S8) | 0 |
| Temperature, ° C. | 27-43 |

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by mole, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A process for treating a tail gas stream from a sulfur recovery zone, comprising:
passing the tail gas stream through, in sequence, a hydrogenation zone, a quench zone, and an acid gas removal zone using a solvent comprising at least one of a dimethyl ether of polyethylene glycol, a N-methyl pyrrolidone, a N-formyl morpholine, a N-acetyl morpholine, a tetrahydro-1,4-oxazine, and a mixture comprising diisopropanolamine and tetrahydrothiophene-1,1-dioxide.

2. The process according to claim 1, wherein the acid gas removal zone further comprises an absorber and a solvent regenerator column.

3. The process according to claim 1, wherein the solvent regenerator column further comprises a reboiler.

4. The process according to claim 1, wherein the hydrogenation zone further comprises:
a first exchanger for preheating the tail gas stream before entering the hydrogenation zone;
a hydrogenation catalytic reactor; and
a second exchanger for reclaiming heat from a hydrogenation catalytic reactor effluent.

5. The process according to claim 1, wherein the quench zone comprises a quench column adapted to receive a stream comprising water.

6. The process according to claim 5, wherein the quench column is adapted to receive the water stream at an upper end and the hydrogenation zone effluent at a lower end.

7. The process according to claim 6, wherein the quench zone further comprises a fluid transfer device and an exchanger for recycling at least a portion of the water exiting from the lower end of the quench column.

8. The process according to claim 1, further comprising compressing an effluent from the quench column.

9. The process according to claim 1, wherein the tail gas stream is at a temperature of no more than about 150° C. exiting the sulfur recovery zone.

10. The process according to claim 4, further comprising providing a reducing gas comprising a syngas to the hydrogenation catalytic reactor.

11. The process according to claim 10, further comprising operating the hydrogenation catalytic reactor at a temperature of about 260—about 330° C.

12. A process for treating a tail gas stream from a sulfur recovery zone, comprising:
A) passing the tail gas stream through a hydrogenation zone, comprising:
1) a first exchanger for preheating the tail gas stream before entering the hydrogenation zone;
2) a hydrogenation catalytic reactor receiving a reducing gas comprising a syngas; and
3) a second exchanger for reclaiming heat from a hydrogenation catalytic reactor effluent.

13. The process according to claim 12, further comprising passing a hydrogenation zone effluent to a quench zone.

14. The process according to claim 13, wherein the quench zone comprises a quench column adapted to receive a stream comprising water.

15. The process according to claim 14, wherein the quench column is adapted to receive the water stream at an upper end and the hydrogenation zone effluent at a lower end.

16. The process according to claim 15, further comprising sending an effluent from the quench zone to an acid gas removal zone.

17. The process according to claim 16, further comprising compressing prior to sending the quench zone effluent to the acid gas removal zone.

18. The process according to claim 16, wherein the acid gas removal zone further comprises an absorber and a solvent regenerator.

19. The process according to claim 18, further comprising operating the absorber at a temperature of about 4—about 60° C. and a pressure of up to about 10,000 kPa.

20. A process for treating an effluent from a gasification zone, comprising:
passing the effluent through, in sequence, at least one of a carbon monoxide shift zone and a carbonyl sulfide hydrolysis zone, an acid gas removal zone, a sulfur recovery zone, and a hydrogenation zone.
